(19) United States
(12) Patent Application Publication
(10) Pub. No.: US 2024/0161246 A1
(43) Pub. Date: May 16, 2024

(54) Image Data Storage and Processing for Preview with Fast and Smooth Transition

(71) Applicant: Micron Technology, Inc., Boise, ID (US)

(72) Inventors: Saideep Tiku, Folsom, CA (US); Poorna Kale, Folsom, CA (US)

(21) Appl. No.: 18/491,582

(22) Filed: Oct. 20, 2023

Related U.S. Application Data
(60) Provisional application No. 63/383,185, filed on Nov. 10, 2022.

(51) Int. Cl. G06T 5/50; G06T 3/40; G06T 9/00

(52) U.S. Cl. CPC G06T 5/50; G06T 3/40; G06T 9/00; G06T 2207/20221

(57) ABSTRACT

A method to generate a series of previews of an image with low latency, includes: retrieving, from a storage device in a first pass, first portions of image data representative of an image; generating, based on the first portions and without at least second portions of the image data, a first preview of the image; presenting the first preview; retrieving, from the storage device in a second pass, the second portions of the image data; generating, based on the first portions and the second portions of the image data, a second preview of the image; and presenting the second preview.

### RELATED APPLICATIONS

The present application claims priority to Prov. U.S. Pat. App. Ser. No. 63/383,185 filed Nov. 10, 2022, the entire disclosures of which application are hereby incorporated herein by reference.

### TECHNICAL FIELD

At least some embodiments disclosed herein relate to storage and processing of data in general and more particularly, but not limited to, image data for preview.

### BACKGROUND

High-resolution image sensors can generate large amounts of data. Loading the entire set of data of an image from a storage device can cause delay in the presentation of the image and the processing of the image. In some systems, a low-resolution version of an image is generated and stored with the full-resolution version of the image to facilitate a faster preview of the image before presentation or processing of the full-resolution version.

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The embodiments are illustrated by way of example and not limitation in the figures of the accompanying drawings in which like references indicate similar elements.

FIG. 1 and FIG. 2 illustrate a technique to organize image data in groups to facilitate gradual reconstruction of an image from low resolution to full resolution according to one embodiment.

FIG. 3 shows an imaging device configured to store and process images according to one embodiment.

FIG. 4 shows an integrated circuit device having an image sensing pixel array, a memory cell array, and circuits to perform inference computations according to one embodiment.

FIG. 5 and FIG. 6 illustrate different configurations of integrated imaging and inference devices according to some embodiments.

FIG. 7 shows the computation of a column of weight bits multiplied by a column of input bits to provide an accumulation result according to one embodiment.

FIG. 8 shows the computation of a column of multi-bit weights multiplied by a column of input bits to provide an accumulation result according to one embodiment.

FIG. 9 shows the computation of a column of multi-bit weights multiplied by a column of multi-bit inputs to provide an accumulation result according to one embodiment.

FIG. 10 shows a computing system configured to process an image using an integrated circuit device and an artificial neural network according to one embodiment.

FIG. 11 shows another computing system according to one embodiment.

FIG. 12 shows an implementation of artificial neural network computations according to one embodiment.

FIG. 13 shows an image processing logic circuit using an inference logic circuit in image compression according to one embodiment.

FIG. 14 shows a method of image storage and processing according to one embodiment.

### DETAILED DESCRIPTION

At least some embodiments disclosed herein provide techniques of image storage and processing for reduced latency and improved user experiences.

An image can be divided into a plurality of sections according to a set of grid lines. Instead of storing the complete image data for each section one after another, it is advantageous to store a portion of the image data of each section one after another in one pass, and another portion of the image data for each section one after another in a subsequent pass. The complete set of portions of the image data of each section can be distributed across the multiple passes.

Each pass stores partial image data for each of the plurality of sections, which allows the generation of a version of a preview of the image with image degradation substantially evenly distributed across the plurality of sections. The preview generated from the image data contained in the initial pass resembles a reduced-resolution version of the original image. Each subsequent pass adds further data for an improved version of the preview of the image, with degradation relative to the original image and improvements relative to the prior version of the preview substantially evenly distributed across the plurality of sections.

When such a multi-pass approach is used, reading the data of one pass from a storage device can take a fraction of the time used to read the entire image data. After reading the data of an initial pass, a degraded version of the image can be constructed for preview. For example, a portion of image data stored in the initial pass for a section can be replicated as an approximation of the remaining portions of image data stored for the section in subsequent passes. Thus, a preview of the image can be generated rapidly with low latency without having to store extra image data generated for the purpose of a preview of the image at a low/reduced resolution.

When a subsequent pass is retrieved from the storage device, an improved version of the image can be constructed for preview. For example, an approximation of a portion of image data used in the construction of the preview of a section based on the data obtained in the prior pass(es) can be replaced with the portion of image data retrieved for the section in the subsequent pass to construct an improved preview. Optionally, the portion of image data retrieved for the section in the subsequent pass can also be replicated as a replacement approximation for one or more portions of image data stored for the section in further passes to be read. Thus, after another fraction of the time used to read the entire image data, an improved preview of the image can be presented. As more passes of image data are read from the storage device, the preview image improves with smooth transition from one version to another until the full-resolution version of the image is shown.

In contrast, when a system stores a low-resolution version of an image together with the full-resolution version of the image, the transition from the display of the low-resolution version of the image to the display of the full-resolution version of the image appears as a sudden change; and the change is delayed for the duration of the retrieval of the image data of full resolution. When the multi-pass approach is used, the user can see a smooth, gradual change of the preview, starting from a low-resolution approximation through a number of improvement iterations towards the full-resolution version of the image over the time of loading the full set of image data. Such a preview technique provides a greatly improved user experience. Optionally, the user may pause or cancel the reading of further passes when a preview generated from reading the first few passes is satisfactory.

The low latency previews generated from reading a portion of the passes can be used as approximations of the image for faster image-based analytics. A sequence of preview images can be analyzed to obtain approximate analytics for the image until the full image is read and analyzed. Thus, previews of the image analytics can also be presented with improvements over a period of time in a way similar to the presentation of the low latency previews of the image.

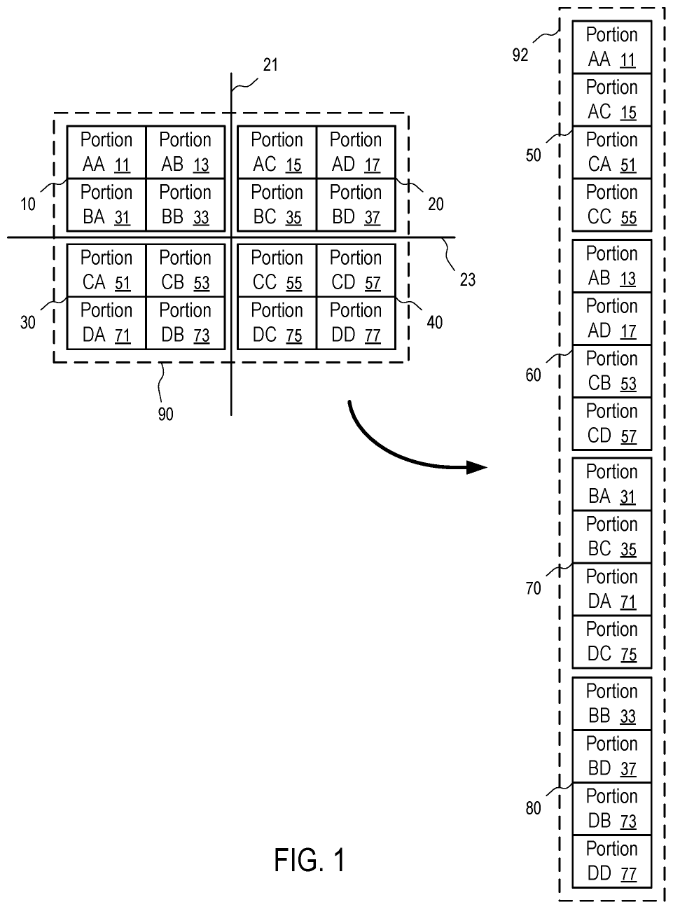

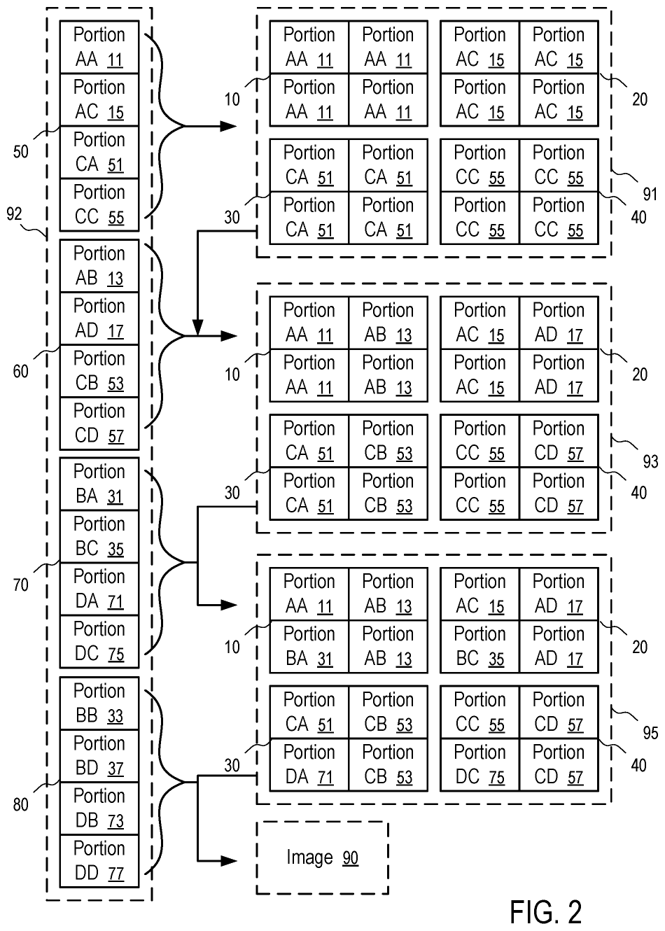

FIG. 1 and FIG. 2 illustrate a technique to organize image data in groups to facilitate gradual reconstruction of an image from low resolution to full resolution according to one embodiment.

FIG. 1 illustrates an image 90 that is divided into a plurality of sections (e.g., 10, 20, 30, 40) according to grid lines (e.g., 21, 23). Each section (e.g., 10) can be configured to contain a separate subset of pixels of the image 90.

For example, the image 90 can be divided into a plurality of rows of sections and a plurality of columns of sections according to a number of horizontal grid lines (e.g., 23) and a number of vertical grid lines (e.g., 21). The horizontal grid lines can be evenly spaced in the vertical direction such that the heights of the sections are the same (or approximately the same). Similarly, the vertical grid lines can be evenly spaced in the horizontal direction such that the widths of the sections are the same (or approximately the same). For simplicity, the sections (e.g., 10, 20, 30, 40) can be configured to have a same size (e.g., height and width in pixels). Since each section can be rendered for preview using a portion of the image data of the section, the sizes of the sections (e.g., height and width in pixels) can be adapted to configure the degree of resolution degradation in the previews of the image 90.

Each section (e.g., 10, 20, 30, or 40) can be further divided into a plurality of portions (e.g., 11, 13, 31, 33; 15, 17, 35, 37; 51, 53, 71, 73; or 55, 57, 75, 77). Each portion (e.g., 11) can be configured to contain a separate subset of pixels of a section (e.g., 10). For example, a section (e.g., 10) can be divided into a plurality of rows of portions (e.g., 11, 13; 31, 33) and a plurality of columns of sections (e.g., 11, 31; 13, 33). For simplicity, the portions (e.g., 11, 53, 35, 77) can be configured to have a same size (e.g., height and width in pixels).

The image data 92 of the image 90 can be stored and retrieved in multiple passes (e.g., 50, 60, 70, 80). Each pass (e.g., 50) is used to store the data of one portion (e.g., 11, 15, 51, or 55) from each section (e.g., 10, 20, 30, or 40) of the image 90. The data of the portions (e.g., 11, 15, 51, 55) stored in a pass (e.g., 50) for the sections (e.g., 10, 20, 30, 40) can be written into and retrieved from a storage device sequentially for improved performance in writing and reading.

Each subsequent pass (e.g., 60) stores the data of one portion (e.g., 13, 17, 53, or 57) from each section (e.g., 10, 20, 30, or 40) of the image 90 that has not yet been stored in the prior pass(es) (e.g., 50). Thus, the number of passes (e.g., 50, 60, 70, 80) for the storage of the image data 92 of the image 90 is equal to the number of portions (e.g., 11, 13, 31, 33) in each section (e.g., 10). Since each pass adds addition image data in improving the preview of the image 90, the sizes of the portions (e.g., height and width in pixels) can be adapted to configure the granularity of incrementally improving previews of the image 90. For simplicity, each pass can be configured to store the data of a portion as a same location within each respective section (e.g., the same row index and column index of the portion within the respective section).

The data of the different passes (e.g., 50, 60, 70, and 80) can be written into a data storage device sequentially. Alternatively, the image data 92 of the portions (e.g., 11, 13, 15, 17, . . . , 71, 73, 75, 77) can be written into a data storage device in a predetermined order. For example, the data of portions can be stored for one row in the image 90 across an entire row of sections (e.g., portions 11, 13, 15, 17) and then next row. For example, the data of portions can be stored one row in the image 90 for one section (e.g., portions 11, 13, 31, 33) and then next section. The order of the storage of the portions of the image 90 can be configured to allow the computing of the addresses of the portions to be retrieved in the order of the multiple passes (e.g., 50, 60, 70, and 80); and the retrieval of the data of the portions can be performed in the order as in the passes (e.g., 50, 60, 70, 80) to facilitate low latency previews.

FIG. 2 illustrates the previews 91, 93, and 95 generated from incrementally retrieving the passes 50, 60, and 70 of the image data 92.

An initial preview 91 of the image 90 having the image data 92 can be generated from the portions 11, 15, 51, and 55 provided in the initial pass 50. Since the pass 50 contains one portion (e.g., 11, 15, 51, or 55) for each section (e.g., 10, 20, 30, or 40) of the image 90, each section can be previewed based on a corresponding portion provided in the pass. Since the image data of other portions (e.g., 13, 31, 33) are scheduled in subsequent passes (e.g., 60, 70, 80) and thus are not yet available at the time of constructing the preview 91, the image data of the portion (e.g., 11) retrieved in the current pass (e.g., 50) can be replicated and used as an approximation of the not-yet-available portions (e.g., 13, 31, 33) in generating the initial preview 91. Since each section (e.g., 10, 20, 30, 40) in the preview 91 shows a representative portion (e.g., 11, 15, 51, 55) of the section, the quality of preview of the sections is substantially consistent across the sections 10, 20, 30, and 40.

Alternative techniques can also be used in the generation of the preview of the section 10 from the portion 11. For example, the portion 11 can be scaled to the size of the section 10 and presented as a preview of the section 10.

The preview 91 resembles a low-resolution version of the image 90 and can be generated without storing extra image data in additional to the image data 92 of the full-resolution version of the image 90.

When the data in the subsequent pass (e.g., 60) becomes available, the combined data from available passes (e.g., 50 and 60) can be used to generate an improved preview 93. For example, since the data for portions 13, 17, 53, and 57 are now available after the completion of reading the pass 60, the respective portions in the prior review 91 can be updated according to data retrieved for the portions 13, 17, 53, and 57.

In FIG. 2, since a row of portions 11 and 13 is available for display, the row can be replicated as a preview of the next row of portions 31 and 33 that are not yet available for display.

Alternative techniques can also be used in the generation of the preview of the section 10 from the available portions 11 and 13. For example, the row of portions 11 and 13 can be scaled to the size of the section 10 and presented as a preview of the section 10.

When data in further passes (e.g., 70, 80) of image data 92 becomes available, the preview of the image 90 can be further improved. When all passes (e.g., 50, 60, 70, 80) are available, the previews 91, 93, and 95 can seamlessly transition into the full-resolution version of the image 90 in display.

Optionally, the processing of the image 90 (e.g., for compression, enhancement, analytics) can be formulated as processing the previews 91, 93, 95, and then the full image 90, with the processing of a subsequent preview or image based on and improving the result of the processing of a prior preview. The processing results for the previews (e.g., 91 or 95) can be presented in connection with the presentation of the previews.

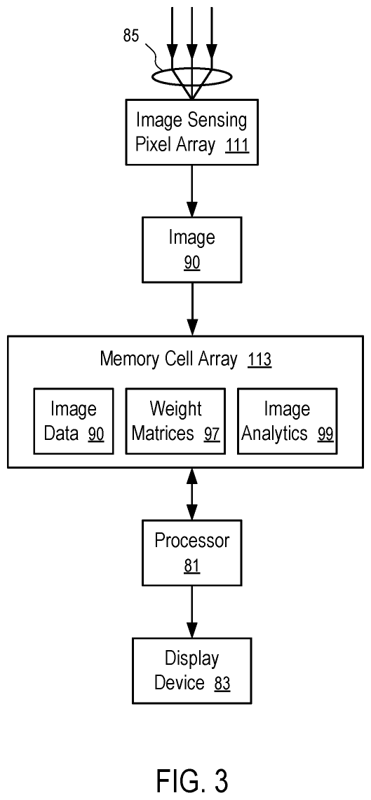

The techniques of FIG. 1 and FIG. 2 can be implemented in an imaging device of FIG. 3.

FIG. 3 shows an imaging device configured to store and process images according to one embodiment. For example, the techniques of FIG. 1 and FIG. 2 to store and process image data in multi-passes 50, 60, 70, and 80 can be implemented in the imaging device of FIG. 3.

In FIG. 3, a lens 85 is configured to project an image 90 of a scene onto an image sensing pixel array 111. The image 90 as captured by the image sensing pixel array 111 can be stored as image data 90 in multiple passes (e.g., 50, 60, 70, 80 as in FIG. 1) via sequential writes to a memory cell array 113 (or another data storage device).

Alternatively, the image data 90 of the image 90 can be stored into the memory cell array 113 in another predetermined format that allows any of the portions (e.g., 11, 33, 53, 55, 77) to be read directly with reading other portions. For example, the portions 11, 13, 15, . . . , 77 can be written into the memory cell array 113 one row of portions after another row; and as a result, the addresses to access the portions according to the passes (e.g., 50, 60, 70, 80) can be computed to generate a sequence of read commands that retrieve the portions according to the order in the passes (e.g., 50, 60, 70, 80). When the portions are read according to the multi-pass order (e.g., as illustrated in FIG. 1 and FIG. 2), an incrementally improving series of previews (e.g., 91, 93, 95) can be presented with low latency in a way as illustrated in FIG. 2.

For example, to display the image 90 on a display device 83, a processor 81 retrieves portions of the image 90 in passes (e.g., 50, 60, 70, 80) as illustrated in FIG. 2. The completion of retrieving the data in each pass allows the generation of a preview, or an incrementally improved preview, of the image 90 on the display device 83.

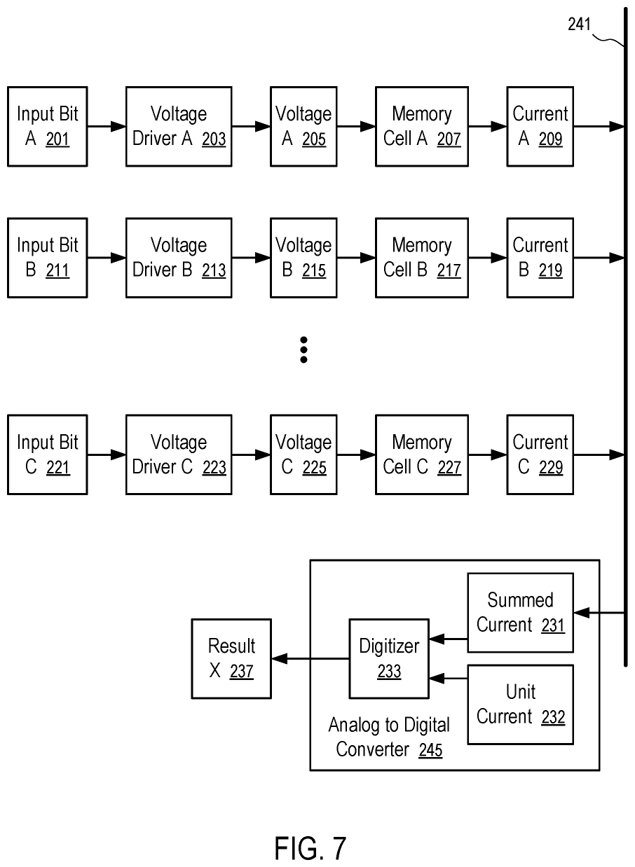

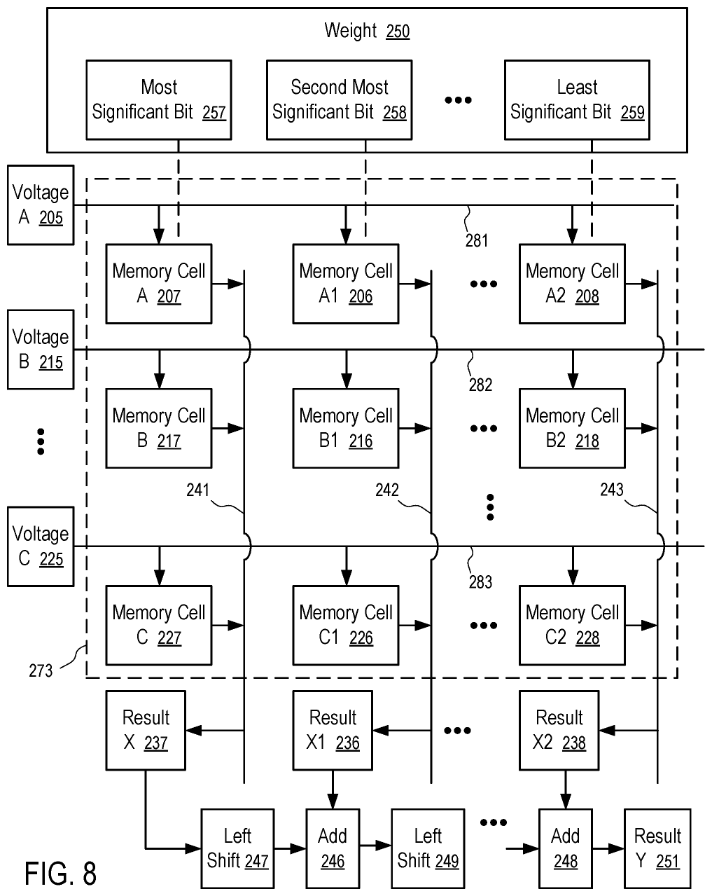

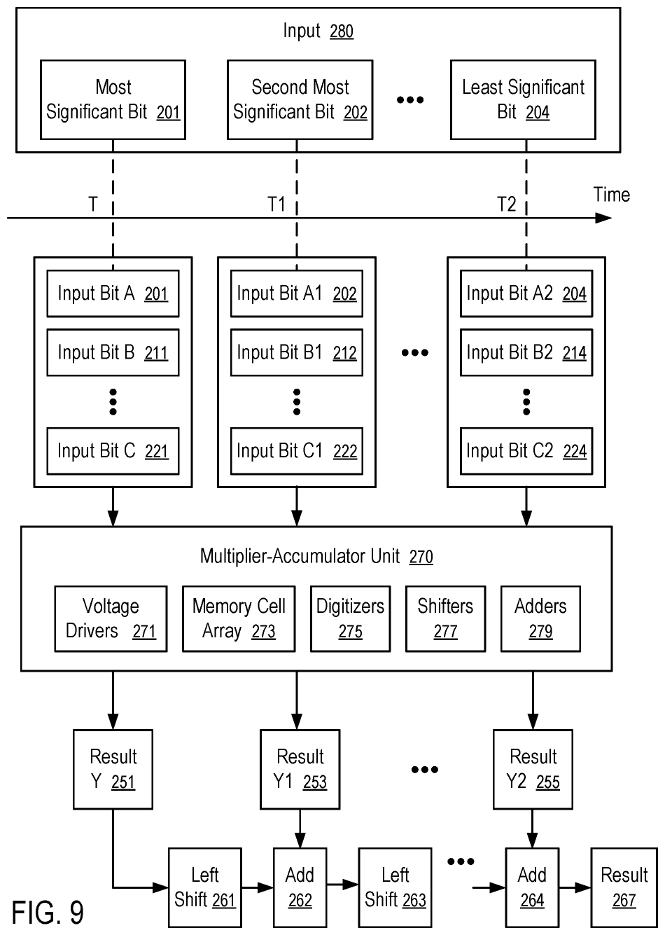

The memory cell array 113 can further store weight matrices 97 in a synapse mode configured to support operations of multiplication and accumulation, as further discussed below in FIG. 7, FIG. 8, and FIG. 9. During multiplication and accumulation operations, a controller coupled to the memory cell array 113 can use voltage drivers to apply read voltages, according to input data, onto wordlines connected to memory cells programmed in the synapse mode to generate currents representative of results of multiplications between the weight data and the input data. The currents are summed in an analog form in bitlines connected to the memory cells programmed in the synapse mode. Current digitizers can convert the currents summed in bitlines to digital results. A portion of the memory cell array 113 can be programmed in a storage mode to store the image data 90. Memory cells programmed in the storage mode can have better performance in data storage and data retrieval than memory cells programmed in the synapse mode, but can lack the support for multiplication and accumulation operations.

The weight matrices 97 can be used in the processing of the image 90, or any of the low-latency previews (e.g., 91, 93, 95) to generate image analytics 99, to compress the image 90, to enhance the image 90, etc. For example, the weight matrices 97 can include weight matrices 97 of an artificial neural network configured to process an image (e.g., 90, or a preview 91, 93, or 95) as an input.

When a portion (e.g., 11) retrieved in a pass (e.g., 50) of the image data 90 is replicated in a preview (e.g., 91) of a section (e.g., 10) and used as the approximation of another portion (e.g., 13), the processing result of the portion (e.g., 11) can be replicated as the approximation of the processing result of the portion (e.g., 13) being approximated without repeating the computations being applied (e.g., using the weight matrices 97) to the portion (e.g., 11). Subsequently, when the portion (e.g., 13) being approximated is read/retrieved in a subsequent pass (e.g., 60), the processing can be applied to the retrieved portion (e.g., 13) to replace or update the approximation without repeating the processing being applied to the portions retrieved in prior passes (e.g., 50). Thus, the computing results can be updated in a way similar to the updating of the previews (e.g., 91, 93, 95) with improved efficiency and reduced latency.

In some implementations, the processor 81 is implemented via an image processing circuit or a microprocessor connected locally to the memory cell array 113 via a high speed interconnect or computer bus. For example, the imaging device of FIG. 3 with the display device 83 can be configured as a digital camera.

In other implementations, the processor 81 is remote to the storage device (e.g., containing the memory cell array 113) storing the image data 90. For example, the processor 81 can access the image data 90 via a computer network or a telecommunications network. When the delay/latency in retrieving the entire image data 90 is noticeable to a user of the display device 83, presenting the previews (e.g., 91, 93, 95) with incremental improvements via reading the image data 90 in passes (e.g., 50, 60, 70, 80) can significantly improve the user experience in viewing the image 90 in the display device 83.

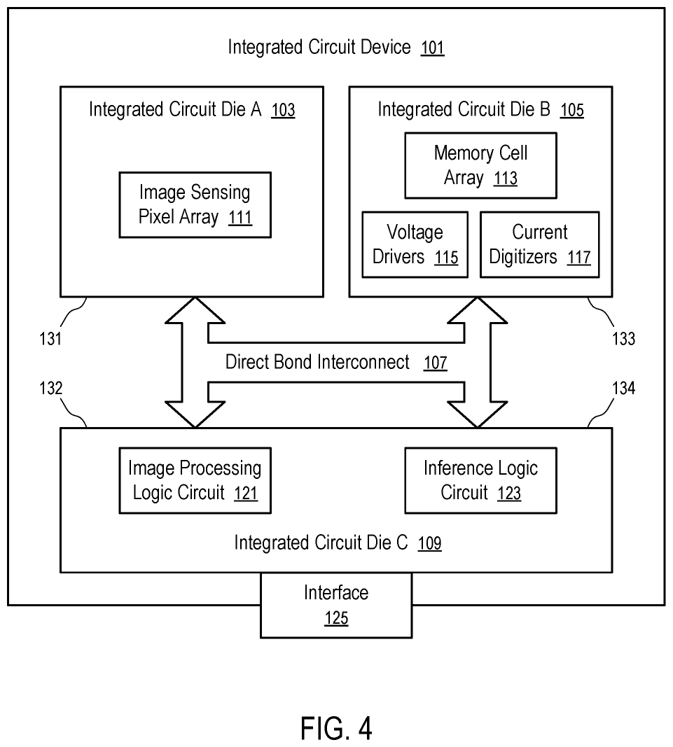

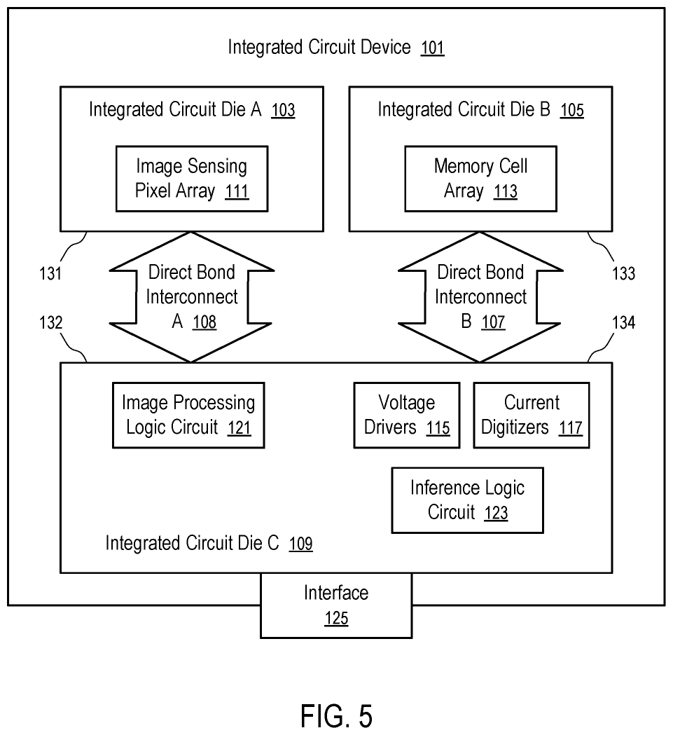

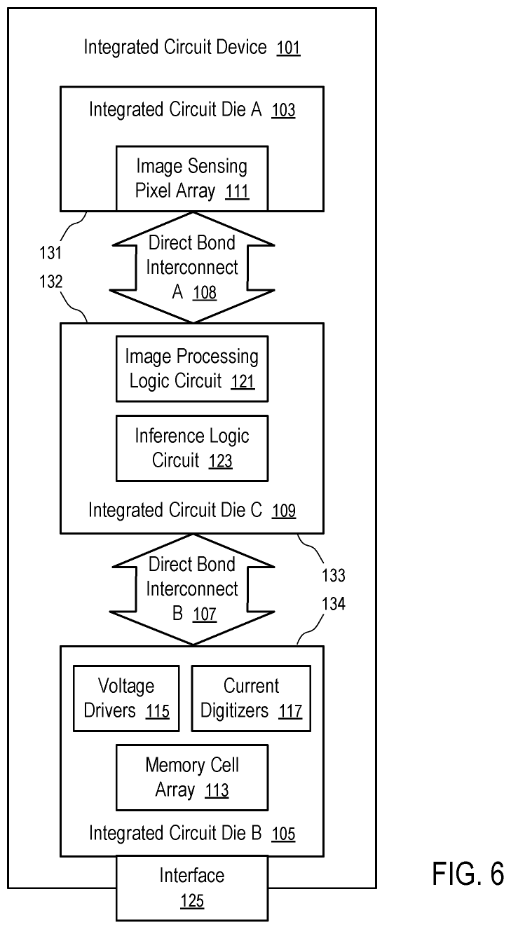

Optionally, the image sensing pixel array 111 and the memory cell array 113 can be integrated in an integrated circuit device in FIG. 4, FIG. 5, and FIG. 6. The integrated circuit device can be configured with an analog capability to support inference computations, such as computations of multiplication and accumulation, and computations of an artificial neural network. In such an integrated circuit device, an image sensor chip containing the image sensing pixel array 111 and a memory chip containing the memory cell array 113 can be bonded to a logic wafer containing logic circuits to facilitate the computations of multiplication and accumulation, and computations of an artificial neural network having an image as an input, to perform image enhancement, to perform image compression, etc.

For example, the memory chip can be connected directly to a portion of the logic wafer via heterogeneous direct bonding, also known as hybrid bonding or copper hybrid bonding.

Direct bonding is a type of chemical bond between two surfaces of material meeting various requirements. Direct bonding of wafers typically includes pre-processing wafers, pre-bonding the wafers at room temperature, and annealing at elevated temperatures. For example, direct bonding can be used to join two wafers of a same material (e.g., silicon); anodic bonding can be used to join two wafers of different materials (e.g., silicon and borosilicate glass); eutectic bonding can be used to form a bonding layer of eutectic alloy based on silicon combining with metal to form a eutectic alloy.

Hybrid bonding can be used to join two surfaces having metal and dielectric material to form a dielectric bond with an embedded metal interconnect from the two surfaces. The hybrid bonding can be based on adhesives, direct bonding of a same dielectric material, anodic bonding of different dielectric materials, eutectic bonding, thermocompression bonding of materials, or other techniques, or any combination thereof.

Copper microbump is a traditional technique to connect dies at packaging level. Tiny metal bumps can be formed on dies as microbumps and connected for assembling into an integrated circuit package. It is difficult to use microbumps for high density connections at a small pitch (e.g., 10 micrometers). Hybrid bonding can be used to implement connections at such a small pitch not feasible via microbumps.

The image sensor chip can be configured on another portion of the logic wafer and connected via hybrid bonding (or a more conventional approach, such as microbumps).

In one configuration, the image sensor chip and the memory chip are placed side by side on the top of the logic wafer. Alternatively, the image sensor chip is connected to one side of the logic wafer (e.g., top surface); and the memory chip is connected to the other side of the logic wafer (e.g., bottom surface).

The logic wafer has a logic circuit configured to process images from the image sensor chip, and another logic circuit configured to operate the memory cells in the memory chip to perform multiplications and accumulation operations.

The memory chip can have multiple layers of memory cells. Each memory cell can be programmed to store a bit of a binary representation of an integer weight. Each input line can be applied a voltage according to a bit of an integer. Columns of memory cells can be used to store bits of a weight matrix; and a set of input lines can be used to control voltage drivers to apply read voltages on rows of memory cells according to bits of an input vector.

The threshold voltage of a memory cell used for multiplication and accumulation operations can be programmed in a synapse mode such that the current going through the memory cell subjecting to a predetermined read voltage is either a predetermined amount representing a value of one stored in the memory cell, or negligible to represent a value of zero stored in the memory cell. When the predetermined read voltage is not applied, the current going through the memory cell is negligible regardless of the value stored in the memory cell. As a result of the configuration, the current going through the memory cell corresponds to the result of 1-bit weight, as stored in the memory cell, multiplied by 1-bit input, corresponding to the presence or the absence of the predetermined read voltage driven by a voltage driver controlled by the 1-bit input. Output currents of the memory cells, representing the results of a column of 1-bit weights stored in the memory cells and multiplied by a column of 1-bit inputs respective, are connected to a common line for summation. The summed current in the common line is a multiple of the predetermined amount; and the multiples can be digitized and determined using an analog to digital converter. Such results of 1-bit to 1-bit multiplications and accumulations can be performed for different significant bits of weights and different significant bits of inputs. The results for different significant bits can be shifted to apply the weights of the respective significant bits for summation to obtain the results of multiplications of multi-bit weights and multi-bit inputs with accumulation, as further discussed below.

Using the capability of performing multiplication and accumulation operations implemented via memory cell arrays, the logic circuit in the logic wafer can be configured to perform inference computations, such as the computation of an artificial neural network.

FIG. 4 shows an integrated circuit device 101 having an image sensing pixel array 111, a memory cell array 113, and circuits to perform inference computations according to one embodiment.

In FIG. 4, the integrated circuit device 101 has an integrated circuit die 109 having logic circuits 121 and 123, an integrated circuit die 103 having the image sensing pixel array 111, and an integrated circuit die 105 having a memory cell array 113.

The integrated circuit die 109 having logic circuits 121 and 123 can be considered a logic chip; the integrated circuit die 103 having the image sensing pixel array 111 can be considered an image sensor chip; and the integrated circuit die 105 having the memory cell array 113 can be considered a memory chip.

In FIG. 4, the integrated circuit die 105 having the memory cell array 113 further includes voltage drivers 115 and current digitizers 117. The memory cell array 113 are connected such that currents generated by the memory cells in response to voltages applied by the voltage drivers 115 are summed in the array 113 for columns of memory cells (e.g., as illustrated in FIG. 7 and FIG. 8); and the summed currents are digitized to generate the sum of bit-wise multiplications. The inference logic circuit 123 can be configured to instruct the voltage drivers 115 to apply read voltages according to a column of inputs, perform shifts and summations to generate the results of a column or matrix of weights multiplied by the column of inputs with accumulation.

The inference logic circuit 123 can be further configured to perform inference computations according to weights stored in the memory cell array 113 (e.g., the computation of an artificial neural network) and inputs derived from the image data generated by the image sensing pixel array 111. Optionally, the inference logic circuit 123 can include a programmable processor that can execute a set of instructions to control the inference computation. Alternatively, the inference computation is configured for a particular artificial neural network with certain aspects adjustable via weights stored in the memory cell array 113. Optionally, the inference logic circuit 123 is implemented via an application-specific integrated circuit (ASIC), a field-programmable gate array (FPGA), or a core of a programmable microprocessor.

In FIG. 4, the integrated circuit die 105 having the memory cell array 113 has a bottom surface 133; and the integrated circuit die 109 having the inference logic circuit 123 has a portion of a top surface 134. The two surfaces 133 and 134 can be connected via hybrid bonding to provide a portion of a direct bond interconnect 107 between the metal portions on the surfaces 133 and 134.

Similarly, the integrated circuit die 103 having the image sensing pixel array 111 has a bottom surface 131; and the integrated circuit die 109 having the inference logic circuit 123 has another portion of its top surface 132. The two surfaces 131 and 132 can be connected via hybrid bonding to provide a portion of the direct bond interconnect 107 between the metal portions on the surfaces 131 and 132.

An image sensing pixel in the array 111 can include a light sensitive element configured to generate a signal responsive to intensity of light received in the element. For example, an image sensing pixel implemented using a complementary metal-oxide-semiconductor (CMOS) technique or a charge-coupled device (CCD) technique can be used.

In some implementations, the image processing logic circuit 121 is configured to pre-process an image from the image sensing pixel array 111 to provide a processed image as an input to the inference computation controlled by the inference logic circuit 123.

Optionally, the image processing logic circuit 121 can also use the multiplication and accumulation function provided via the memory cell array 113.

In some implementations, the direct bond interconnect 107 includes wires for writing image data from the image sensing pixel array 111 to a portion of the memory cell array 113 for further processing by the image processing logic circuit 121 or the inference logic circuit 123, or for retrieval via an interface 125.

The inference logic circuit 123 can buffer the result of inference computations in a portion of the memory cell array 113.

The interface 125 of the integrated circuit device 101 can be configured to support a memory access protocol, or a storage access protocol or any combination thereof. Thus, an external device (e.g., a processor, a central processing unit) can send commands to the interface 125 to access the storage capacity provided by the memory cell array 113.

For example, the interface 125 can be configured to support a connection and communication protocol on a computer bus, such as a peripheral component interconnect express (PCIe) bus, a serial advanced technology attachment (SATA) bus, a universal serial bus (USB) bus, a compute express link, etc. In some embodiments, the interface 125 can be configured to include an interface of a solid-state drive (SSD), such as a ball grid array (BGA) SSD. In some embodiments, the interface 125 is configured to include an interface of a memory module, such as a double data rate (DDR) memory module, a dual in-line memory module, etc. The interface 125 can be configured to support a communication protocol such as a protocol according to non-volatile memory express (NVMe), non-volatile memory host controller interface specification (NVMHCIS), etc.

The integrated circuit device 101 can appear to be a memory sub-system from the point of view of a device in communication with the interface 125. Through the interface 125 an external device (e.g., a processor, a central processing unit) can access the storage capacity of the memory cell array 113. For example, the external device can store and update weight matrices and instructions for the inference logic circuit 123, retrieve images generated by the image sensing pixel array 111 and processed by the image processing logic circuit 121, and retrieve results of inference computations controlled by the inference logic circuit 123.

In some implementations, some of the circuits (e.g., voltage drivers 115, or current digitizers 117, or both) are implemented in the integrated circuit die 109 having the inference logic circuit 123, as illustrated in FIG. 5.

In FIG. 4, the image sensor chip and the memory chip are placed side by side on the same side (e.g., top side) of the logic chip. Alternatively, the image sensor chip and the memory chip can be placed on different sides (e.g., top surface and bottom surface) of the logic chip, as illustrated in FIG. 6.

FIG. 5 and FIG. 6 illustrate different configurations of integrated imaging and inference devices according to some embodiments.

Similar to the integrated circuit device 101 of FIG. 4, the device 101 in FIG. 5 and FIG. 6 can also have an integrated circuit die 109 having image processing logic circuits 121 and inference logic circuit 123, an integrated circuit die 103 having an image sensing pixel array 111, and an integrated circuit die 105 having a memory cell array 113.

However, in FIG. 5, the voltage drivers 115 and current digitizers 117 are configured in the integrated circuit die 109 having the inference logic circuit 123. Thus, the integrated circuit die 105 of the memory cell array 113 can be manufactured to contain memory cells and wire connections without added complications of voltage drivers 115 and current digitizers 117.

In FIG. 5, a direct bond interconnect 108 connects the image sensing pixel array 111 to the image processing logic circuit 121. Alternatively, microbumps can be used to connect the image sensing pixel array 111 to the image processing logic circuit 121.

In FIG. 5, another direct bond interconnect 107 connects the memory cell array 113 to the voltage drivers 115 and the current digitizers 117. Since the direct bond interconnects 107 and 108 are separate from each other, the image sensor chip may not write image data directly into the memory chip without going through the logic circuits in the logic chip. Alternatively, a direct bond interconnect 107 as illustrated in FIG. 4 can be configured to allow the image sensor chip to write image data directly into the memory chip without going through the logic circuits in the logic chip.

Optionally, some of the voltage drivers 115, the current digitizers 117, and the inference logic circuits 123 can be configured in the memory chip, while the remaining portion is configured in the logic chip.

FIG. 4 and FIG. 5 illustrate configurations where the memory chip and the image sensor chip are placed side-by-side on the logic chip. During manufacturing of the integrated circuit devices 101, memory chips and image sensor chips can be placed on a surface of a logic wafer containing the circuits of the logic chips to apply hybrid bonding. The memory chips and image sensor chips can be combined to the logic wafer at the same time. Subsequently, the logic wafer having the attached memory chips and image sensor chips can be divided into chips of the integrated circuit devices (e.g., 101).

Alternatively, as in FIG. 6, the image sensor chip and the memory chip are placed on different sides of the logic chip.

In FIG. 6, the image sensor chip is connected to the logic chip via a direct bond interconnect 108 on the top surface 132 of the logic chip. Alternatively, microbumps can be used to connect the image sensor chip to the logic chip. The memory chip is connected to the logic chip via a direct bond interconnect 107 on the bottom surface 133 of the logic chip. During the manufacturing of the integrated circuit devices 101, an image sensor wafer can be attached to, bonded to, or combined with the top surface of the logic wafer in a process/operation; and the memory wafer can be attached to, bonded to, or combined with the bottom side of the logic wafer in another process. The combined wafers can be divided into chips of the integrated circuit devices 101.

FIG. 6 illustrates a configuration in which the voltage drivers 115 and current digitizers 117 are configured in the memory chip having the memory cell array 113. Alternatively, some of the voltage drivers 115, the current digitizers 117, and the inference logic circuit 123 are configured in the memory chip, while the remaining portion is configured in the logic chip disposed between the image sensor chip and the memory chip. In other implementations, the voltage drivers 115, the current digitizers 117, and the inference logic circuit 123 are configured in the logic chip, in a way similar to the configuration illustrated in FIG. 5.

In FIG. 4, FIG. 5, and FIG. 6, the interface 125 is positioned at the bottom side of the integrated circuit device 101, while the image sensor chip is positioned at the top side of the integrated device 101 to receive incident light for generating images.

The voltage drivers 115 in FIG. 4, FIG. 5, and FIG. 6 can be controlled to apply voltages to program the threshold voltages of memory cells in the array 113. Data stored in the memory cells can be represented by the levels of the programmed threshold voltages of the memory cells.

A typical memory cell in the array 113 has a nonlinear current to voltage curve. When the threshold voltage of the memory cell is programmed to a first level to represent a stored value of one, the memory cell allows a predetermined amount of current to go through when a predetermined read voltage higher than the first level is applied to the memory cell. When the predetermined read voltage is not applied (e.g., the applied voltage is zero), the memory cell allows a negligible amount of current to go through, compared to the predetermined amount of current. On the other hand, when the threshold voltage of the memory cell is programmed to a second level higher than the predetermined read voltage to represent a stored value of zero, the memory cell allows a negligible amount of current to go through, regardless of whether the predetermined read voltage is applied. Thus, when a bit of weight is stored in the memory as discussed above, and a bit of input is used to control whether to apply the predetermined read voltage, the amount of current going through the memory cell as a multiple of the predetermined amount of current corresponds to the digital result of the stored bit of weight multiplied by the bit of input. Currents representative of the results of 1-bit by 1-bit multiplications can be summed in an analog form before digitized for shifting and summing to perform multiplication and accumulation of multi-bit weights against multi-bit inputs, as further discussed below.

FIG. 7 shows the computation of a column of weight bits multiplied by a column of input bits to provide an accumulation result according to one embodiment.

In FIG. 7, a column of memory cells 207, 217, . . . , 227 (e.g., in the memory cell array 113 of an integrated circuit device 101) can be programmed to have threshold voltages at levels representative of weights stored one bit per memory cell.

Voltage drivers 203, 213, . . . , 223 (e.g., in the voltage drivers 115 of an integrated circuit device 101) are configured to apply voltages 205, 215, . . . , 225 to the memory cells 207, 217, . . . , 227 respectively according to their received input bits 201, 211, . . . , 221.

For example, when the input bit 201 has a value of one, the voltage driver 203 applies the predetermined read voltage as the voltage 205, causing the memory cell 207 to output the predetermined amount of current as its output current 209 if the memory cell 207 has a threshold voltage programmed at a lower level, which is lower than the predetermined read voltage, to represent a stored weight of one, or to output a negligible amount of current as its output current 209 if the memory cell 207 has a threshold voltage programmed at a higher level, which is higher than the predetermined read voltage, to represent a stored weight of zero. However, when the input bit 201 has a value of zero, the voltage driver 203 applies a voltage (e.g., zero) lower than the lower level of threshold voltage as the voltage 205 (e.g., does not apply the predetermined read voltage), causing the memory cell 207 to output a negligible amount of current at its output current 209 regardless of the weight stored in the memory cell 207. Thus, the output current 209 as a multiple of the predetermined amount of current is representative of the result of the weight bit, stored in the memory cell 207, multiplied by the input bit 201.

Similarly, the current 219 going through the memory cell 217 as a multiple of the predetermined amount of current is representative of the result of the weight bit, stored in the memory cell 217, multiplied by the input bit 211; and the current 229 going through the memory cell 227 as a multiple of the predetermined amount of current is representative of the result of the weight bit, stored in the memory cell 227, multiplied by the input bit 221.

The output currents 209, 219, . . . , and 229 of the memory cells 207, 217, . . . , 227 are connected to a common line 241 for summation. The summed current 231 is compared to the unit current 232, which is equal to the predetermined amount of current, by a digitizer 233 of an analog to digital converter 245 to determine the digital result 237 of the column of weight bits, stored in the memory cells 207, 217, . . . , 227 respectively, multiplied by the column of input bits 201, 211, . . . , 221 respectively with the summation of the results of multiplications.

The sum of negligible amounts of currents from memory cells connected to the line 241 is small when compared to the unit current 232 (e.g., the predetermined amount of current). Thus, the presence of the negligible amounts of currents from memory cells does not alter the result 237 and is negligible in the operation of the analog to digital converter 245.

In FIG. 7, the voltages 205, 215, . . . , 225 applied to the memory cells 207, 217, . . . , 227 are representative of digitized input bits 201, 211, . . . , 221; the memory cells 207, 217, . . . , 227 are programmed to store digitized weight bits; and the currents 209, 219, . . . , 229 are representative of digitized results. Thus, the memory cells 207, 217, . . . , 227 do not function as memristors that convert analog voltages to analog currents based on their linear resistances over a voltage range; and the operating principle of the memory cells in computing the multiplication is fundamentally different from the operating principle of a memristor crossbar. When a memristor crossbar is used, conventional digital to analog converters are used to generate an input voltage proportional to inputs to be applied to the rows of memristor crossbar. When the technique of FIG. 7 is used, such digital to analog converters can be eliminated; and the operation of the digitizer 233 to generate the result 237 can be greatly simplified. The result 237 is an integer that is no larger than the count of memory cells 207, 217, . . . , 227 connected to the line 241. The digitized form of the output currents 209, 219, . . . , 229 can increase the accuracy and reliability of the computation implemented using the memory cells 207, 217, . . . , 227.

In general, a weight involving a multiplication and accumulation operation can be more than one bit. Multiple columns of memory cells can be used to store the different significant bits of weights, as illustrated in FIG. 8 to perform multiplication and accumulation operations.

The circuit illustrated in FIG. 7 can be considered a multiplier-accumulator unit configured to operate on a column of 1-bit weights and a column of 1-bit inputs. Multiple such circuits can be connected in parallel to implement a multiplier-accumulator unit to operate on a column of multi-bit weights and a column of 1-bit inputs, as illustrated in FIG. 8.

The circuit illustrated in FIG. 7 can also be used to read the data stored in the memory cells 207, 217, . . . , 227. For example, to read the data or weight stored in the memory cell 207, the input bits 211, . . . , 221 can be set to zero to cause the memory cells 217, . . . , 227 to output negligible amount of currents into the line 241 (e.g., as a bitline). The input bit 201 is set to one to cause the voltage driver 203 to apply the predetermined read voltage. Thus, the result 237 from the digitizer 233 provides the data or weight stored in the memory cell 207. Similarly, the data or weight stored in the memory cell 217 can be read via applying one as the input bit 211 and zeros as the remaining input bits in the column; and data or weight stored in the memory cell 227 can be read via applying one as the input bit 221 and zeros as the other input bits in the column.

In general, the circuit illustrated in FIG. 7 can be used to select any of the memory cells 207, 217, . . . , 227 for read or write. A voltage driver (e.g., 203) can apply a programming voltage pulse to adjust the threshold voltage of a respective memory cell (e.g., 207) to erase data, to store data or weigh, etc.

FIG. 8 shows the computation of a column of multi-bit weights multiplied by a column of input bits to provide an accumulation result according to one embodiment.

In FIG. 8, a weight 250 in a binary form has a most significant bit 257, a second most significant bit 258, . . . , a least significant bit 259. The significant bits 257, 258, . . . , 259 can be stored in memory cells 207, 206, . . . , 208 in a number of columns respectively in an array 273. The significant bits 257, 258, . . . , 259 of the weight 250 are to be multiplied by the input bit 201 represented by the voltage 205 applied on a line 281 (e.g., a wordline) by a voltage driver 203 (e.g., as in FIG. 7).

Similarly, memory cells 217, 216, . . . , 218 can be used to store the corresponding significant bits of a next weight to be multiplied by a next input bit 211 represented by the voltage 215 applied on a line 282 (e.g., a wordline) by a voltage driver 213 (e.g., as in FIG. 7); and memory cells 227, 226, . . . , 228 can be used to store corresponding of a weight to be multiplied by the input bit 221 represented by the voltage 225 applied on a line 283 (e.g., a wordline) by a voltage driver 223 (e.g., as in FIG. 7).

The most significant bits (e.g., 257) of the weights (e.g., 250) stored in the respective rows of memory cells in the array 273 are multiplied by the input bits 201, 211, . . . , 221 represented by the voltages 205, 215, . . . , 225 and then summed as the current 231 in a line 241 and digitized using a digitizer 233, as in FIG. 7, to generate a result 237 corresponding to the most significant bits of the weights.

Similarly, the second most significant bits (e.g., 258) of the weights (e.g., 250) stored in the respective rows of memory cells in the array 273 are multiplied by the input bits 201, 211, . . . , 221 represented by the voltages 205, 215, . . . , 225 and then summed as a current in a line 242 and digitized to generate a result 236 corresponding to the second most significant bits.

Similarly, the least most significant bits (e.g., 259) of the weights (e.g., 250) stored in the respective rows of memory cells in the array 273 are multiplied by the input bits 201, 211, . . . , 221 represented by the voltages 205, 215, . . . , 225 and then summed as a current in a line 243 and digitized to generate a result 238 corresponding to the least significant bit.

The most significant bit can be left shifted by one bit to have the same weight as the second significant bit, which can be further left shifted by one bit to have the same weight as the next significant bit. Thus, the result 237 generated from multiplication and summation of the most significant bits (e.g., 257) of the weights (e.g., 250) can be applied an operation of left shift 247 by one bit; and the operation of add 246 can be applied to the result of the operation of left shift 247 and the result 236 generated from multiplication and summation of the second most significant bits (e.g., 258) of the weights (e.g., 250). The operations of left shift (e.g., 247, 249) can be used to apply weights of the bits (e.g., 257, 258, . . . ) for summation using the operations of add (e.g., 246, . . . , 248) to generate a result 251. Thus, the result 251 is equal to the column of weights in the array 273 of memory cells multiplied by the column of input bits 201, 211, . . . , 221 with multiplication results accumulated.

In general, an input involving a multiplication and accumulation operation can be more than 1 bit. Columns of input bits can be applied one column at a time to the weights stored in the array 273 of memory cells to obtain the result of a column of weights multiplied by a column of inputs with results accumulated as illustrated in FIG. 9.

The circuit illustrated in FIG. 8 can be used to read the data stored in the array 273 of memory cells. For example, to read the data or weight 250 stored in the memory cells 207, 206, . . . , 208, the input bits 211, . . . , 221 can be set to zero to cause the memory cells 217, 216, . . . , 218, . . . , 227, 226, . . . , 228 to output negligible amount of currents into the line 241, 242, . . . , 243 (e.g., as bitlines). The input bit 201 is set to one to cause the voltage driver 203 to apply the predetermined read voltage as the voltage 205. Thus, the results 237, 236, . . . , 238 from the digitizers (e.g., 233) connected to the lines 241, 242, . . . , 243 provide the bits 257, 258, . . . , 259 of the data or weight 250 stored in the row of memory cells 207, 206, . . . , 208. Further, the result 251 computed from the operations of shift 247, 249, . . . and operations of add 246, . . . , 248 provides the weight 250 in a binary form.

In general, the circuit illustrated in FIG. 8 can be used to select any row of the memory cell array 273 for read. Optionally, different columns of the memory cell array 273 can be driven by different voltage drivers. Thus, the memory cells (e.g., 207, 206, . . . , 208) in a row can be programmed to write data in parallel (e.g., to store the bits 257, 258, . . . , 259) of the weight 250.

FIG. 9 shows the computation of a column of multi-bit weights multiplied by a column of multi-bit inputs to provide an accumulation result according to one embodiment.

In FIG. 9, the significant bits of inputs (e.g., 280) are applied to a multiplier-accumulator unit 270 at a plurality of time instances T, T1, . . . , T2.

For example, a multi-bit input 280 can have a most significant bit 201, a second most significant bit 202, . . . , a least significant bit 204.

At time T, the most significant bits 201, 211, . . . , 221 of the inputs (e.g., 280) are applied to the multiplier-accumulator unit 270 to obtain a result 251 of weights (e.g., 250), stored in the memory cell array 273, multiplied by the column of bits 201, 211, . . . , 221 with summation of the multiplication results.

For example, the multiplier-accumulator unit 270 can be implemented in a way as illustrated in FIG. 8. The multiplier-accumulator unit 270 has voltage drivers 271 connected to apply voltages 205, 215, . . . , 225 representative of the input bits 201, 211, . . . , 221. The multiplier-accumulator unit 270 has a memory cell array 273 storing bits of weights as in FIG. 8. The multiplier-accumulator unit 270 has digitizers 275 to convert currents summed on lines 241, 242, . . . , 243 for columns of memory cells in the array 273 to output results 237, 236, . . . , 238. The multiplier-accumulator unit 270 has shifters 277 and adders 279 connected to combine the column result 237, 236, . . . , 238 to provide a result 251 as in FIG. 8.

Similarly, at time T1, the second most significant bits 202, 212, . . . , 222 of the inputs (e.g., 280) are applied to the multiplier-accumulator unit 270 to obtain a result 253 of weights (e.g., 250) stored in the memory cell array 273 and multiplied by the vector of bits 202, 212, . . . , 222 with summation of the multiplication results.

Similarly, at time T2, the least significant bits 204, 214, . . . , 224 of the inputs (e.g., 280) are applied to the multiplier-accumulator unit 270 to obtain a result 255 of weights (e.g., 250), stored in the memory cell array 273, multiplied by the vector of bits 202, 212, . . . , 222 with summation of the multiplication results.

The result 251 generated from multiplication and summation of the most significant bits 201, 211, . . . , 221 of the inputs (e.g., 280) can be applied an operation of left shift 261 by one bit; and the operation of add 262 can be applied to the result of the operation of left shift 261 and the result 253 generated from multiplication and summation of the second most significant bits 202, 212, . . . , 222 of the inputs (e.g., 280). The operations of left shift (e.g., 261, 263) can be used to apply weights of the bits (e.g., 201, 202, . . . ) for summation using the operations of add (e.g., 262, . . . , 264) to generate a result 267. Thus, the result 267 is equal to the weights (e.g., 250) in the array 273 of memory cells multiplied by the column of inputs (e.g., 280) respectively and then summed.

A plurality of multiplier-accumulator unit 270 can be connected in parallel to operate on a matrix of weights multiplied by a column of multi-bit inputs over a series of time instances T, T1, . . . , T2.

The multiplier-accumulator units (e.g., 270) illustrated in FIG. 7, FIG. 8, and FIG. 9 can be implemented in integrated circuit devices 101 in FIG. 4, FIG. 5, and FIG. 6.

In some implementations, the memory cell array 113 in the integrated circuit devices 101 in FIG. 4, FIG. 5, and FIG. 6 has multiple layers of memory cell arrays.

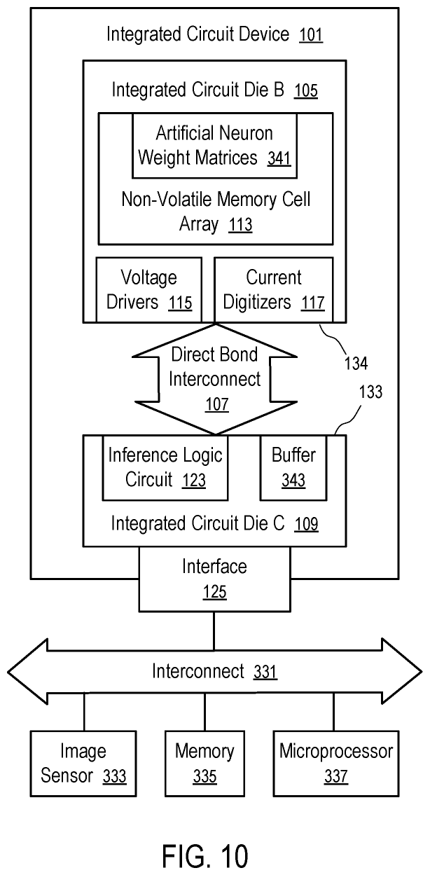

FIG. 10 shows a computing system configured to process an image using an integrated circuit device and an artificial neural network according to one embodiment.

In FIG. 10, an integrated circuit device 101 has a memory chip (e.g., integrated circuit die 105) and a logic chip (e.g., integrated circuit die 109) with variations similar to the integrated circuit devices 101 of FIG. 4, FIG. 5, and FIG. 6. Optionally, the integrated circuit device 101 of FIG. 10 can have an image chip (e.g., integrated circuit die 103) as in FIG. 4, FIG. 5, or FIG. 6. Alternatively, the integrated circuit device 101 of FIG. 10 can be manufactured to have no image chip.

In FIG. 10, the interface 125 of the integrated circuit device 101 can receive commands to write an image into the integrated circuit device 101 as a memory device, or a storage device, or both.

For example, the image sensor 333 can write an image through the interconnect 331 (e.g., one or more computer buses) into the interface 125. Alternatively, a microprocessor 337 can function as a host system to retrieve an image from the image sensor 333, optionally buffer the image in the memory 335, and write the image to the interface 125. The interface 125 can place the image data in the buffer 343 as an input to the inference logic circuit 123.

In some implementations, when the integrated circuit device 101 has an image sensing pixel array 111 (e.g., as in FIG. 4, FIG. 5, and FIG. 6), the image chip or the image processing logic circuit 121 can send image data to the buffer 343 directly, or through the interface 125.

In response to the image data in the buffer 343, the inference logic circuit 123 can generate a column of inputs. The memory cell array 113 in the memory chip (e.g., integrated circuit die 105) can store an artificial neuron weight matrix 341 configured to weigh on the inputs to an artificial neural network. The inference logic circuit 123 can instruct the voltage drivers 115 to apply a column of significant bits of the inputs a time to an array of memory cells storing the artificial neuron weight matrix 341 to obtain a column of results (e.g., 251) using the technique of FIG. 8 and FIG. 9. The inference logic circuit 123 can transform the column of results (e.g., according to activation functions of artificial neurons) to generate a next column of inputs to be further weighted on using a further artificial neuron weight matrix 341. The process can continue until a last artificial neuron weight matrix 341 is applied to produce the output of the artificial neural network.

The inference logic circuit 123 can be configured to place the output of the artificial neural network into the buffer 343 for retrieval as a response to, or replacement of, the image written to the interface 125. Optionally, the inference logic circuit 123 can be configured to write the output of the artificial neural network into the memory cell array 113 in the memory chip. In some implementations, an external device (e.g., the image sensor, the microprocessor 337) writes an image into the interface 125; and in response to the integrated circuit device 101 generates the output of the artificial neural network in response to the image and write the output as a replacement of the image into the memory chip.

The memory cells in the memory cell array 113 can be non-volatile. Thus, once the weight matrices 341 are written into the memory cell array 113, the integrated circuit device 101 has the computation capability of the artificial neural network without further configuration or assistance from an external device (e.g., a host system). The computation capability can be used immediately upon supplying power to the integrated circuit device 101 without the need to boot up and configure the integrated circuit device 101 by a host system (e.g., microprocessor 337 running an operating system). The power to the integrated circuit device 101 (or a portion of it) can be turned off when the integrated circuit device 101 is not used in computing an output of an artificial neural network, and not used in reading or write data to the memory chip. Thus, the energy consumption of the computing system can be reduced.

In some implementations, the inference logic circuit 123 is programmable to perform operations of forming columns of inputs, applying the weights stored in the memory chip, and transforming columns of data (e.g., according to activation functions of artificial neurons). The instructions can also be stored in the non-volatile memory cell array 113 in the memory chip.

In some implementations, the inference logic circuit 123 includes an array of identical logic circuits configured to perform the computation of some types of activation functions, such as step activation function, rectified linear unit (ReLU) activation function, heaviside activation function, logistic activation function, gaussian activation function, multiquadratics activation function, inverse multiquadratics activation function, polyharmonic splines activation function, folding activation functions, ridge activation functions, radial activation functions, etc.

In some implementations, the multiplication and accumulation operations in an activation function are performed using multiplier-accumulator units 270 implemented using memory cells in the array 113.

Some activation functions can be implemented via multiplication and accumulation operations with fixed weights.

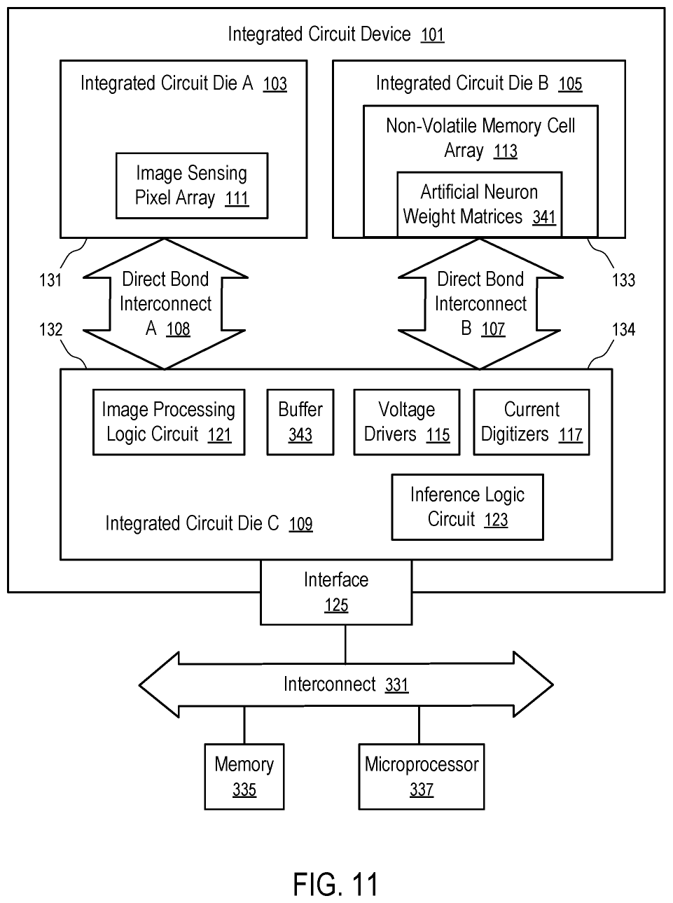

FIG. 11 shows another computing system according to one embodiment.

The integrated circuit device 101 in FIG. 11 has an integrated circuit die 109 with an inference logic circuit 123 and a non-volatile memory cell array 113 as in FIG. 10.

In FIG. 11, the voltage drivers 115 and the current digitizers 117 are configured in the logic chip (e.g., integrated circuit die 109 having the inference logic circuit 123). Alternatively, at least a portion of the voltage drivers 115 and the current digitizers 117 can be implemented in the memory chip (e.g., integrated circuit die 105 having the memory cell array 113).

In FIG. 11, the integrated circuit device 101 includes an image chip (e.g., integrated circuit die 103 having image sensing pixel array 111).

An image processing logic circuit 121 in the logic chip can pre-process an image from the image sensing pixel array 111 as an input to the inference logic circuit 123. After the image processing logic circuit 121 stores the input into the buffer 343, the inference logic circuit 123 can perform the computation of an artificial neural network in a way similar to the integrated circuit device 101 of FIG. 10.

For example, the inference logic circuit 123 can store the output of the artificial neural network into the memory chip in response to the input in the buffer 343.

Optionally, the image processing logic circuit 121 can also store one or more version of the image captured by the image sensing pixel array 111 in the memory chip as a solid-state drive.

An application running in the microprocessor 337 can send a command to the interface 125 to read at a memory address in the memory chip. In response, the image sensing pixel array 111 can capture an image; the image processing logic circuit 121 can process the image to generate an input in the buffer; and the inference logic circuit 123 can generate an output of the artificial neural network responding to the input. The integrated circuit device 101 can provide the output as the content retrieved at the memory address; and the application running in the microprocessor 337 can determine, based on the output, whether to read further memory addresses to retrieve the image or the input generated by the image processing logic circuit 121. For example, the artificial neural network can be trained to generate a classification of whether the image captures an object of interest and if so, a bounding box of a portion of the image containing the image of the object and a classification of the object. Based on the output of the artificial neural network, the application running in the microprocessor 337 can decide whether to retrieve the image, or the image of the object in the bounding box, or both.

In some implementations, the original image, or the input generated by the image processing logic circuit 121, or both can be placed in the buffer 343 for retrieval by the microprocessor 337. If the microprocessor 337 decides not to retrieve the image data in view of the output of the artificial neural network, the image data in the buffer 343 can be discarded when the microprocessor 337 sends a command the interface 125 to read a next image.

Optionally, the buffer 343 is configured with sufficient capacity to store data for up to a predetermined number of images. When the buffer 343 is full, the oldest image data in the buffer is erased.

When the integrated circuit device 101 is not in an active operation (e.g., capturing an image, operating the interface 125, or performing the artificial neural network computations), the integrated circuit device 101 can automatically enter a low power mode to avoid or reduce power consumption. A command to the interface 125 can wake up the integrated circuit device 101 to process the command.

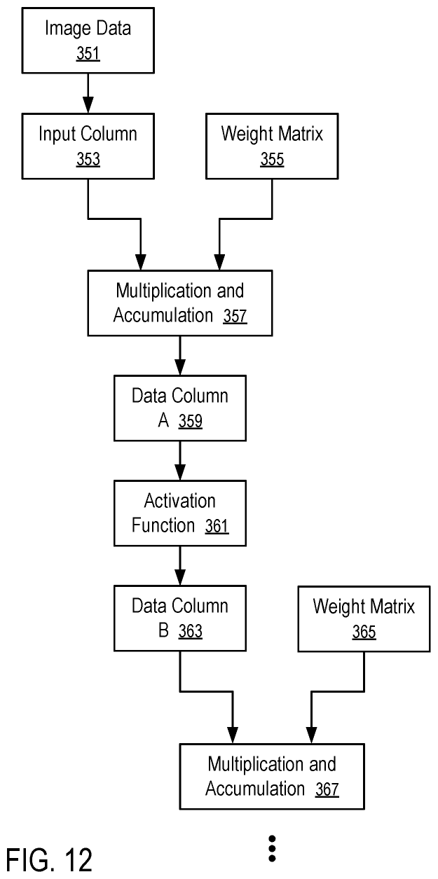

FIG. 12 shows an implementation of artificial neural network computations according to one embodiment. For example, the computations of FIG. 12 can be implemented in the integrated circuit devices 101 of FIG. 4, FIG. 5, FIG. 6, FIG. 10, and FIG. 11.

In FIG. 12, image data 351 can be provided as an input to an artificial neural network from an image sensing pixel array 111, an image processing logic circuit 121, an image sensor 333, or a microprocessor 337.

An inference logic circuit 123 in an integrated circuit device 101 can arrange the pixel values from the image data 351 into a column 353 of inputs.

A weight matrix 355 is stored in one or more layers of the memory cell array 113 in the memory chip of the integrated circuit device 101.

A multiplication and accumulation 357 combined the input columns 353 and the weight matrix 355. For example, the inference logic circuit 123 identifies the storage location of the weight matrix 355 in the memory chip, instructs the voltage drivers 115 to apply, according to the bits of the input column, voltages to memory cells storing the weights in the matrix 355, and retrieve the multiplication and accumulation results (e.g., 267) from the logic circuits (e.g., adder 264) of the multiplier-accumulator units 270 containing the memory cells.

The multiplication and accumulation results (e.g., 267) provide a column 359 of data representative of combined inputs to a set of input artificial neurons of the artificial neural network. The inference logic circuit 123 can use an activation function 361 to transform the data column 359 to a column 363 of data representative of outputs from the next set of artificial neurons. The outputs from the set of artificial neurons can be provided as inputs to a next set of artificial neurons. A weight matrix 365 includes weights applied to the outputs of the neurons as inputs to the next set of artificial neurons and biases for the neurons. A multiplication and accumulation 367 can be performed in a similar way as the multiplication and accumulation 357. Such operations can be repeated from multiple set of artificial neurons to generate an output of the artificial neural network.

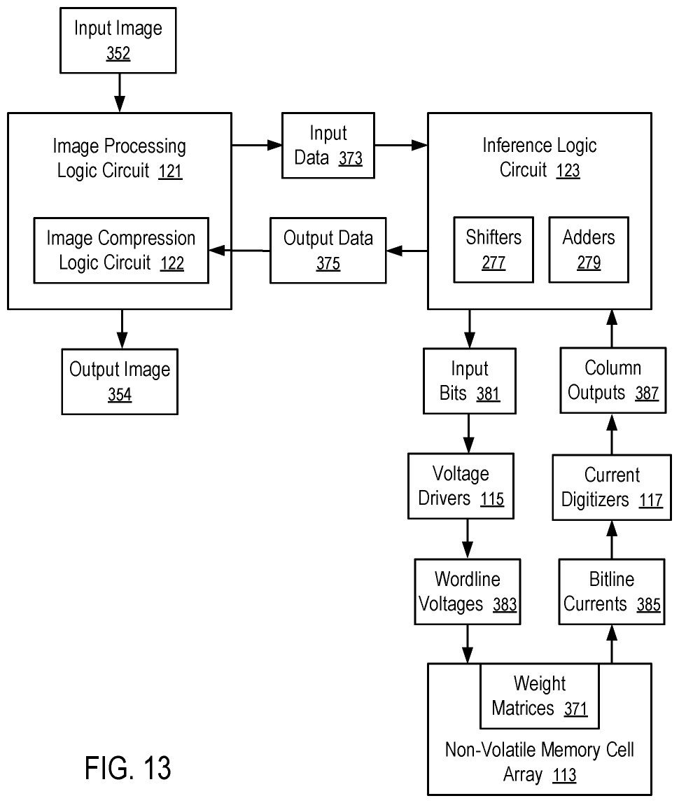

FIG. 13 shows an image processing logic circuit using an inference logic circuit in image compression according to one embodiment. For example, the technique of FIG. 13 can be implemented in integrated circuit devices 101 of FIG. 4, FIG. 5, FIG. 6, FIG. 10, and FIG. 11.

In FIG. 13, an image processing logic circuit 121 in a logic chip (e.g., integrated circuit die 109) in an integrated circuit device 101 is configured to compress an input image 352 to generate an output image 354. The image compression can include lossy compression, lossless compression, image trimming, etc.

The image compression computation can include, or formulated to include, multiplication and accumulation operations based on weight matrices 371 stored in a memory chip (e.g., integrated circuit die 105) in the integrated circuit devices 101. Preferably, the weight matrices 371 do not change for typical image compression such that the weight matrices 371 can be written into the non-volatile memory cell array 113 without repeatedly erasing and programming so that the useful life of the non-volatile memory cell array 113 can be extended. Some types of non-volatile memory cells (e.g., cross point memory) can have a high budget for erasing and programming. When the memory cells in the array 113 can tolerate a high number of erasing and programming cycles, the image compression computation can also be formulated to use weight matrices 371 that change during the computations of image compression.

The image processing logic circuit 121 can include an image compression logic circuit 122 configured to generate input data 373 for the inference logic circuit 123 to apply operations of multiplication and accumulation on weight matrices 371 to generate output data 375. The input data 373 can include, for example, pixel values of the input image 352, an identification/address of a weight matrix 371 stored in the memory cell array 113, or other data derived from the pixel values, or any combination thereof. After the operations of the multiplication and accumulation, the image processing logic circuit 121 can use the output data 375 received from the inference logic circuit 123 in compressing the input image 352 into the output image 354.

The input data 373 identifies a matrix 371 stored in the memory cell array 113 and a column of inputs (e.g., 280). In response, the inference logic circuit 123 uses a column of input bits 381 to control voltage drivers 115 to apply wordline voltages 383 onto rows of memory cells storing the weights of a matrix 371 identified by the input data 373. The voltage drivers 115 apply voltages of predetermined magnitudes on wordlines to represent the input bits 381. The memory cells in the memory cell array 113 are configured to output currents that are negligible or multiples of a predetermined amount of current 232. Thus, the combination of the voltage drivers 115 and the memory cells storing the weight matrices 371 functions as digital to analog converters configured to convert the results of bits of weights (e.g., 250) multiplied by the bits of inputs (e.g., 280) into output currents (e.g., 209, 219, . . . , 229). Bitlines (e.g., lines 241, 242, . . . , 243) in the memory cell array 113 sum the currents in an analog form. The summed currents (e.g., 231) in the bitlines (e.g., line 241) are digitized as column outputs 387 by the current digitizers 117 for further processing in a digital form (e.g., using shifters 277 and adders 279 in the inference logic circuit 123) to obtain the output data 375.

As illustrated in FIG. 7 and FIG. 8, the wordline voltages 383 (e.g., 205, 215, . . . , 225) are representative of the applied input bits 381 (e.g., 201, 211, . . . , 221) and cause the memory cells in the array 113 to generate output currents (e.g., 209, 21, . . . , 229). The memory cell array 113 connects output currents from each column of memory cells to a respective line (e.g., 241, 242, . . . , or 243) to sum the output currents for a respective column. Current digitizers 117 can determine the bitline currents 385 in the lines (e.g., bitlines) in the array 113 as multiples of a predetermined amount of current 232 to provide the summation results (e.g., 237, 236, . . . , 238) as the column outputs 387. Shifters 277 and adders 279 of the inference logic circuit 123 (or in the memory chip) can be used to combine the column outputs 387 with corresponding weights for different significant bits of weights (e.g., 250) as in FIG. 8 and with corresponding weights (e.g., 250) for the different significant bits of the inputs (e.g., 280) as in FIG. 9 to generate results of multiplication and accumulation.

The inference logic circuit 123 can provide the results of multiplication and accumulation as the output data 375. In response, the image compression logic circuit 122 can provide further input data 373 to obtain further output data 375 by combining the input data 373 with a weight matrix 371 in the memory cell array 113 through operations of multiplication and accumulation. Based on output data 375 generated by the inference logic circuit 123, the image compression logic circuit 122 converts the input image 352 into the output image 354.

For example, the input data 373 can be the pixel values of the input image 352 and an offset; and the weight matrix 371 can be applied to scale the pixel values and apply the offset.

For example, the input data 373 can be the pixel values of the input image 352; and the weight matrix 371 can be configured to compute transform coefficients of predetermined functions (e.g., cosine functions) having a sum representative of the pixel values, such as coefficients of discrete cosine transform of a spatial distribution of the pixel values. For example, the image compression logic circuit 122 can be configured to perform the computations of color space transformation, request the inference logic circuit 123 to compute the coefficients for discrete cosine transform (DCT), perform quantization of the DCT coefficients, and encode the results of quantization to generate the output image 354 (e.g., in a joint photographic experts group (JPEG or JPG) format).

For example, the input data 373 can be the pixel values of the input image 352; and the computation of an artificial neural network having the weight matrices 371 can be performed by the inference logic circuit 123 to identify one or more segments of the input image 352 containing content of interest. The image compression logic circuit 122 can adjust compression ratios for different segments of input image 352 to preserve more details in segments of interest and to compress more aggressively in other segments. Optionally, regions outside of the segments of interest can be deleted.

For example, an artificial neural network can be trained to rank the levels of interest in different segments of the input image 352. After the inference logic circuit 123 identifies the levels of interest in the output data 375 based on the computation of the artificial neural network responsive to the pixel values of the input image 352, the image compression logic circuit 122 can adjust compression ratios for different segments according to the ranked levels of interest of the segments. Optionally, the artificial neural network can be trained to predict the desired compression ratios of different segments of the input image 352.

In some implementations, a compression technique formulated using an artificial neural network is used. The output data 375 includes data representative of a compressed image; and the image compression logic circuit 122 can encode the output data 375 to provide the output image 354 according to a predetermined format.

Image enhancements and image analytics can be performed in a way similar to the image compression of FIG. 13.

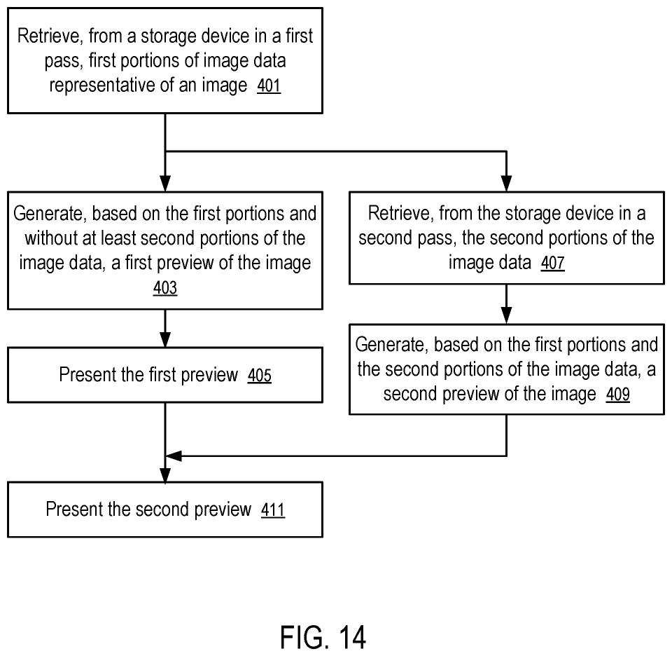

FIG. 14 shows a method of image storage and processing according to one embodiment. For example, the method of FIG. 14 can be performed in an imaging device of FIG. 3 or an integrated circuit device 101 of FIG. 4, FIG. 5, FIG. 6, FIG. 10, or FIG. 11 using the multi-pass techniques of FIG. 1 and FIG. 2, and using the multiplication and accumulation techniques of FIG. 7, FIG. 8, and FIG. 9.

At block 401, an apparatus retrieves, from a storage device (e.g., memory cell array 113, integrated circuit device 101) in a first pass (e.g., 50), first portions (e.g., 11, 15, 51, 55) of image data 92 representative of an image 90.

For example, the apparatus can include an imaging device of FIG. 3, an integrated circuit device of FIG. 4, FIG. 5 or FIG. 6, or a computing system of FIG. 10 or FIG. 11.

For example, the apparatus can include: an image sensing array 111; a lens 85 configured to project, onto the image sensing array 113, an image 90 having a plurality of sections 10, 20, 30, 40; the storage device configured to store the image data 92 representative of the image 90 captured via the image sensing array 111; and a display device 83. The apparatus can include a processor 81, an image processing logic circuit 121, or a microprocessor 337, or a combination of such processing circuits to generate previews of the 91, 93, 95 of the image 90, or to write the image data 92 into the storage device (e.g., according to the passes 50, 60, 70, 80) with optional image compression and image enhancements applied to the portions (e.g., 11, 33, 55, 77) of the image 90.

For example, the apparatus can include the integrated circuit device 101 having: a first integrated circuit die 103 having the image sensing pixel array 111; a second integrated circuit die 105 having a non-volatile memory cell array 113; a third integrated circuit die 109 having a logic circuit (e.g., 121, 123) configured to perform image enhancement, image compression, or image analytics, using weight matrices (e.g., 97, 341) programmed in a synapse mode in the memory cell array 113; and an integrated circuit package enclosing at least the first integrated circuit die 103, the second integrated circuit die 105, and the third integrated circuit die 109.

For example, the integrated circuit device 101 can further include voltage drivers 115 and current digitizers 117 configured on the second integrated circuit die 105, or the third integrated circuit die 109. Each respective memory cell in the array 113 can be programmable in a synapse mode to support multiplication and accumulation as in FIG. 7, or in a storage mode for improved performances in data storage and retrieval without support for multiplication and accumulation.

For example, the integrated circuit device 101 can program, in a first pass 50 and in the storage mode, first memory cells in the memory cell array 113 to store the first portions (e.g., 11, 15, 51, 55) of the image data 92, where the first portions (e.g., 11, 15, 51, 55) are configured to be uniformly distributed across the image 90. Then, the integrated circuit device 101 can program, in a second pass 60 and in the storage mode, second memory cells in the memory cell array 113 to store second portions (e.g., 13, 17, 53, 57) of the image data 92, where the second portions (e.g., 13, 17, 53, 57) are configured to be uniformly distributed across the image 90.

For example, the image 90 has a plurality of sections 10, 20, 30 and 40 as divided by a set of grid lines (e.g., 21, 23); the first portions (e.g., 11, 15, 51, 55) are from the sections (e.g., 10, 20, 30, 40) respectively to each represent a section (e.g., 10, 20, 30, or 40); and the second portions (e.g., 13, 17, 53, 57) are from the sections respectively (e.g., 10, 20, 30, 40) to each improve the representation of a section (e.g., 10, 20, 30, or 40).

To facilitate multiplication and accumulation involving the weight matrices (e.g., 97, 341), the integrated circuit device 101 can program, in the synapse mode, third memory cells (e.g., in array 273) in the memory cell array 113 to store the weight matrices (e.g., 97, 341) of an image processing operation configured to process the image 90.

For example, each respective memory cell in the memory cell array 113 is: programmable in the synapse mode to output a predetermined amount of current in response to a predetermined read voltage when the respective memory cell has a threshold voltage programmed to represent a value of one, or a negligible amount of current in response to the predetermined read voltage when the threshold voltage is programmed to represent a value of zero; and programmable in the storage mode to have a threshold voltage positioned in one of a plurality of voltage regions, each representative of one of a plurality of predetermined values.

To perform an operation of multiplication and accumulation, the integrated circuit device 101 can convert, using the voltage drivers 115 connected to the wordlines (e.g., 281, 282, . . . , 283) and into output currents (e.g., 209, 219, . . . , 229) of the third memory cells summed in the bitlines (e.g., 241, 242, . . . , 243), results of bitwise multiplications of bits in an input (e.g., bits 201, 211, . . . , 221; 381) and bits (e.g., 257, 258, . . . , 259; bits in weight matrices 371) stored in the third memory cells. The integrated circuit device 101 can digitize, using the current digitizers (e.g., 233, 117) connected to the bitlines (e.g., 241, 242, . . . , 243), currents (e.g., 231) in the bitlines to obtain column outputs (e.g., 237, 236, . . . , 238; 387). Using the column outputs (e.g., 387) the integrated circuit device 101 can generate results of an operation of multiplication and accumulation applied to the input and the weight matrices (e.g., 97, 341) stored in the third memory cells (e.g., in array 273).

For example, the logic circuit (e.g., 121, 123) in the third integrated circuit die 109 can be configured to use the weight matrices (e.g., 97, 341) to apply the image processing operation to the first portions (e.g., 11, 15, 51, 55) and then to the second portions (e.g., 13, 17, 53, 57) for image compression, image enhancement, or image analytics in generating previews 91, 93 of the image 90.

For example, the logic circuit (e.g., 121, 123) in the third integrated circuit die 109 can be configured to use the weight matrices (e.g., 97, 341) to use the weight matrices (e.g., 97, 341) to perform the image processing operation to generate data representative of the first portions (e.g., 11, 15, 51, 55) through image compression or image enhancement and similarly to generate the second portions (e.g., 13, 17, 53, 57) during capturing of the image 90 for storage in the memory cell array 113.

Optionally, during the capturing of the image 90, the processor 81 (or the image processing logic circuit 121 or the microprocessor 337) can be configured to write the first portions (e.g., 11, 15, 51, 55) into the storage device at first sequential addresses and write the second portions (e.g., 13, 17, 53, 57) into the storage device at second sequential addresses following the first sequential addresses.

At block 403, the apparatus generates, based on the first portions (e.g., 11, 15, 51, 55) and without at least the second portions (e.g., 13, 17, 53, 57) of the image data 92, a first preview 91 of the image.

For example, each respective section (e.g., 10) in the sections can be represented by a respective portion (e.g., 11) in the first portions in the first preview (e.g., 91) via scaling the respective portion (e.g., 11) as an approximation of the respective section (e.g., 10) in the first preview (e.g., 91), or via replicating the respective portion (e.g., 11) as an approximation remaining portions (e.g., 13, 31, 33) in the respective section (e.g., 10) to be retrieved in subsequent passes (e.g., 60, 70, 80).

At block 405, the apparatus presents the first preview 91 via the display device 83.

After retrieval of the first portions (e.g., 11, 15, 51, 55) at block 401 and while generating and presenting the first preview 91 at blocks 403 and 405, the apparatus can continue retrieving, at block 407 and from the storage device in a second pass (e.g., 60), the second portions (e.g., 13, 17, 53, 57) of the image data 92, and generating, at block 409 and based on the first portions (e.g., 11, 15, 51, 55) and the second portions (e.g., 13, 17, 53, 57) of the image data 92, a second preview 93 of the image 90, which is an improvement over the first preview 91.

When the second preview 93 of the image 90 is available, the apparatus presents, at block 411, the second preview 93 as a replacement of the first preview 91.

For example, the approximation of the second portions (e.g., 13, 17, 53, 57) made using the replicated copies of the first portions (e.g., 11, 15, 51, 55) in the first preview 91 can be replaced with the second portions (e.g., 13, 17, 53, 57) in the generating of the second preview 93 from the first preview 91 and the second portions (e.g., 11, 15, 51, 55).

For example, a representative image of each section (e.g., 10) can be constructed from a combination of portions (e.g., 11 and 13) from the first portions and the second portions; and the representative image can be scaled as an approximation of the corresponding section (e.g., 10) in the second preview 93.

The process as illustrated in FIG. 14 can continue to retrieve, in a further pass (e.g., 70 or 80), further portions (e.g., 31, 35, 71, 75; or 33, 37, 73, 77), to generate a further preview (e.g., 93) or the full display of the image 90. Thus, in a duration of retrieving the image data 92 in passes (e.g., 50, 60, 70, 80), a series of low-latency previews (e.g., 91, 93, 95) can be presented.

Optionally, the apparatus can apply an image processing operation to each of the previews (e.g., 91, 93, 95) and then the full image 90 to provide processing results using the weight matrices (e.g., 97, 341). The processing results can include image analytics 99, image enhancements, image compression or decompression, etc. The processing results can be presented alone side with the previews 91, 93, 95 and the full image 90.

Integrated circuit devices 101 (e.g., as in FIG. 4, FIG. 5, FIG. 6, FIG. 10, and FIG. 11) can be configured as a storage device, a memory module, or a hybrid of a storage device and memory module. Examples of a storage device include a solid-state drive (SSD), a flash drive, a universal serial bus (USB) flash drive, an embedded multi-media controller (eMMC) drive, a universal flash storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The integrated circuit devices 101 (e.g., as in FIG. 4, FIG. 5, FIG. 6, FIG. 10, and FIG. 11) can be installed in a computing system as a memory sub-system having an embedded image sensor and an inference computation capability. Such a computing system can be a computing device such as a desktop computer, a laptop computer, a network server, a mobile device, a portion of a vehicle (e.g., airplane, drone, train, automobile, or other conveyance), an internet of things (IoT) enabled device, an embedded computer (e.g., one included in a vehicle, industrial equipment, or a networked commercial device), or such a computing device that includes memory and a processing device.

In general, a computing system can include a host system that is coupled to one or more memory sub-systems (e.g., integrated circuit device 101 of FIG. 4, FIG. 5, FIG. 6, FIG. 10, and FIG. 11). In one example, a host system is coupled to one memory sub-system. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

For example, the host system can include a processor chipset (e.g., processing device) and a software stack executed by the processor chipset. The processor chipset can include one or more cores, one or more caches, a memory controller (e.g., NVDIMM controller), and a storage protocol controller (e.g., PCIe controller, SATA controller). The host system uses the memory sub-system, for example, to write data to the memory sub-system and read data from the memory sub-system.

The host system can be coupled to the memory sub-system via a physical host interface. Examples of a physical host interface include, but are not limited to, a serial advanced technology attachment (SATA) interface, a peripheral component interconnect express (PCIe) interface, a universal serial bus (USB) interface, a fibre channel, a serial attached SCSI (SAS) interface, a double data rate (DDR) memory bus interface, a small computer system interface (SCSI), a dual in-line memory module (DIMM) interface (e.g., DIMM socket interface that supports double data rate (DDR)), an open NAND flash interface (ONFI), a double data rate (DDR) interface, a low power double data rate (LPDDR) interface, a compute express link (CXL) interface, or any other interface. The physical host interface can be used to transmit data between the host system and the memory sub-system. The host system can further utilize an NVM express (NVMe) interface to access components (e.g., memory devices) when the memory sub-system is coupled with the host system by the PCIe interface. The physical host interface can provide an interface for passing control, address, data, and other signals between the memory sub-system and the host system. In general, the host system can access multiple memory sub-systems via a same communication connection, multiple separate communication connections, or a combination of communication connections.

The processing device of the host system can be, for example, a microprocessor, a central processing unit (CPU), a processing core of a processor, an execution unit, etc. In some instances, the controller can be referred to as a memory controller, a memory management unit, or an initiator. In one example, the controller controls the communications over a bus coupled between the host system and the memory sub-system. In general, the controller can send commands or requests to the memory sub-system for desired access to memory devices. The controller can further include interface circuitry to communicate with the memory sub-system. The interface circuitry can convert responses received from the memory sub-system into information for the host system.

The controller of the host system can communicate with the controller of the memory sub-system to perform operations such as reading data, writing data, or erasing data at the memory devices, and other such operations. In some instances, the controller is integrated within the same package of the processing device. In other instances, the controller is separate from the package of the processing device. The controller or the processing device can include hardware such as one or more integrated circuits (ICs), discrete components, a buffer memory, or a cache memory, or a combination thereof. The controller or the processing device can be a microcontroller, special-purpose logic circuitry (e.g., a field programmable gate array (FPGA), an application specific integrated circuit (ASIC), etc.), or another suitable processor.

The memory devices can include any combination of the different types of non-volatile memory components and volatile memory components. The volatile memory devices can be, but are not limited to, random access memory (RAM), such as dynamic random access memory (DRAM) and synchronous dynamic random access memory (SDRAM).

Some examples of non-volatile memory components include a negative-and (or, NOT AND) (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, or a PLC portion of memory cells, or any combination thereof. The memory cells of the memory devices can be grouped as pages that can refer to a logical unit of the memory device used to store data. With some types of memory (e.g., NAND), pages can be grouped to form blocks.

Although non-volatile memory devices such as 3D cross-point type and NAND type memory (e.g., 2D NAND, 3D NAND) are described, the memory device can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), spin transfer torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller (or controller for simplicity) can communicate with the memory devices to perform operations such as reading data, writing data, or erasing data at the memory devices and other such operations (e.g., in response to commands scheduled on a command bus by controller). The controller can include hardware such as one or more integrated circuits (ICs), discrete components, or a buffer memory, or a combination thereof. The hardware can include digital circuitry with dedicated (i.e., hard-coded) logic to perform the operations described herein. The controller can be a microcontroller, special-purpose logic circuitry (e.g., a field programmable gate array (FPGA), an application specific integrated circuit (ASIC), etc.), or another suitable processor.

The controller can include a processing device (processor) configured to execute instructions stored in a local memory. In the illustrated example, the local memory of the controller includes an embedded memory configured to store instructions for performing various processes, operations, logic flows, and routines that control operation of the memory sub-system, including handling communications between the memory sub-system and the host system.

In some embodiments, the local memory can include memory registers storing memory pointers, fetched data, etc. The local memory can also include read-only memory (ROM) for storing micro-code. While the example memory sub-system includes a controller, in another embodiment of the present disclosure, a memory sub-system does not include a controller, and can instead rely upon external control (e.g., provided by an external host, or by a processor or controller separate from the memory sub-system).

In general, the controller can receive commands or operations from the host system and can convert the commands or operations into instructions or appropriate commands to achieve the desired access to the memory devices. The controller can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices. The controller can further include host interface circuitry to communicate with the host system via the physical host interface. The host interface circuitry can convert the commands received from the host system into command instructions to access the memory devices as well as convert responses associated with the memory devices into information for the host system.

The memory sub-system can also include additional circuitry or components that are not illustrated. In some embodiments, the memory sub-system can include a cache or buffer (e.g., DRAM) and address circuitry (e.g., a row decoder and a column decoder) that can receive an address from the controller and decode the address to access the memory devices.

In some embodiments, the memory devices include local media controllers that operate in conjunction with the memory sub-system controller to execute operations on one or more memory cells of the memory devices. An external controller (e.g., memory sub-system controller) can externally manage the memory device (e.g., perform media management operations on the memory device). In some embodiments, a memory device is a managed memory device, which is a raw memory device combined with a local media controller for media management within the same memory device package. An example of a managed memory device is a managed NAND (MNAND) device.

The controller or a memory device can include a storage manager configured to implement storage functions discussed above. In some embodiments, the controller in the memory sub-system includes at least a portion of the storage manager. In other embodiments, or in combination, the controller or the processing device in the host system includes at least a portion of the storage manager. For example, the controller, the controller, or the processing device can include logic circuitry implementing the storage manager. For example, the controller, or the processing device (processor) of the host system, can be configured to execute instructions stored in memory for performing the operations of the storage manager described herein. In some embodiments, the storage manager is implemented in an integrated circuit chip disposed in the memory sub-system. In other embodiments, the storage manager can be part of firmware of the memory sub-system, an operating system of the host system, a device driver, or an application, or any combination therein.

In one embodiment, an example machine of a computer system within which a set of instructions, for causing the machine to perform any one or more of the methods discussed herein, can be executed. In some embodiments, the computer system can correspond to a host system that includes, is coupled to, or utilizes a memory sub-system or can be used to perform the operations described above. In alternative embodiments, the machine can be connected (e.g., networked) to other machines in a LAN, an intranet, an extranet, or the internet, or any combination thereof. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a personal digital assistant (PDA), a cellular telephone, a web appliance, a server, a network router, a switch or bridge, a network-attached storage facility, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system includes a processing device, a main memory (e.g., read-only memory (ROM), flash memory, dynamic random access memory (DRAM) such as synchronous DRAM (SDRAM) or Rambus DRAM (RDRAM), static random access memory (SRAM), etc.), and a data storage system, which communicate with each other via a bus (which can include multiple buses).

Processing device represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device can also be one or more special-purpose processing devices such as an application specific integrated circuit (ASIC), a field programmable gate array (FPGA), a digital signal processor (DSP), network processor, or the like. The processing device is configured to execute instructions for performing the operations and steps discussed herein. The computer system can further include a network interface device to communicate over the network.

The data storage system can include a machine-readable medium (also known as a computer-readable medium) on which is stored one or more sets of instructions or software embodying any one or more of the methodologies or functions described herein. The instructions can also reside, completely or at least partially, within the main memory and within the processing device during execution thereof by the computer system, the main memory and the processing device also constituting machine-readable storage media. The machine-readable medium, data storage system, or main memory can correspond to the memory sub-system.

In one embodiment, the instructions include instructions to implement functionality corresponding to the operations described above. While the machine-readable medium is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result.

The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special-purpose circuitry, with or without software instructions, such as using application-specific integrated circuit (ASIC) or field-programmable gate array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method, comprising:
retrieving, from a storage device in a first pass, first portions of image data representative of an image;
generating, based on the first portions and without at least second portions of the image data, a first preview of the image;
presenting the first preview;
retrieving, from the storage device in a second pass, the second portions of the image data;
generating, based on the first portions and the second portions of the image data, a second preview of the image; and
presenting the second preview.

2. The method of claim 1, wherein the first portions are uniformly distributed across the image; and the second portions are uniformly distributed across the image.

3. The method of claim 2, wherein the image has a plurality of sections; the first portions are from the sections respectively; and the second portions are from the sections respectively.

4. The method of claim 3, wherein each respective section in the sections is represented by a respective portion in the first portions in the first preview.

5. The method of claim 4, further comprising:
scaling the respective portion as an approximation of the respective section in the first preview.

6. The method of claim 4, further comprising:
replicating the first portions as an approximation of the second portions in the first preview; and
replacing the approximation of the second portions in the first preview with the second portions in the generating of the second preview from the first preview and the second portions.

7. The method of claim 4, wherein the retrieving of the second portions is performed in parallel with the generating of the first preview and the presenting of the first preview; and the second preview is presented to replace the first preview.

8. The method of claim 4, wherein each respective section in the sections is represented by a scaled version of a combination of a respective portion in the first portions and a respective portion in the second portions.

9. The method of claim 4, further comprising:
writing, into the storage device, the first portions sequentially; and
writing, into the storage device, the second portions sequentially after the first portions.

10. The method of claim 4, further comprising:
applying an image processing operation to the first preview to generate a first result; and
applying the second processing operations to the second preview to generate a second result from updating the first result.

11. The method of claim 10, wherein the image processing operation includes image compression, image enhancement, or image analytics.

12. The method of claim 11, further comprising:
generating, in an image sensing pixel array of an integrated circuit device, the image data;
programming, in a storage mode, first memory cells in a memory cell array in the integrated circuit device to store the first portions;
programming, in the storage mode, second memory cells in the memory cell array to store the second portions; and
programming, in a synapse mode, third memory cells in the memory cell array to store weight matrices;
wherein the image processing operation is based on the weight matrices.

13. A device, comprising:
a first integrated circuit die having an image sensing pixel array;
a second integrated circuit die having a memory cell array; and
a third integrated circuit die having a logic circuit configured to:
program, in a first pass and in a storage mode, first memory cells in the memory cell array to store first portions of image data representative of an image captured by the image sensing pixel array, wherein the first portions are uniformly distributed across the image;
program, in a second pass and in the storage mode, second memory cells in the memory cell array to store second portions of the image data, wherein the second portions are uniformly distributed across the image;
program, in a synapse mode, third memory cells in the memory cell array to store weight matrices of an image processing operation configured to process the image.

14. The device of claim 13, wherein the logic circuit is configured to use the weight matrices to perform the image processing operation to the first portions and to the second portions for image compression, image enhancement, or image analytics.

15. The device of claim 13, wherein the logic circuit is configured to use the weight matrices to perform the image processing operation to generate the first portions through image compression or image enhancement and to generate the second portions.

16. The device of claim 15, further comprising:
voltage drivers;
current digitizers; and
an integrated circuit package enclosing the voltage drivers, the current digitizers, the first integrated circuit die, the second integrated circuit die, and the third integrated circuit die;
wherein the third memory cells are connected to wordlines and bitlines;
wherein the logic circuit is configured to perform operations of multiplication and accumulation in the image processing operation; and
wherein the logic circuit is configured to:
convert, using the voltage drivers connected to the wordlines and into output currents of the third memory cells summed in the bitlines, results of bitwise multiplications of bits in an input and bits stored in the third memory cells;
digitize, using the current digitizers connected to the bitlines, currents in the bitlines to obtain column outputs; and
generate results of an operation of multiplication and accumulation applied to the input and the weight matrices stored in the third memory cells.

17. The device of claim 16, wherein each respective memory cell in the memory cell array is:
programmable in the synapse mode to output:
a predetermined amount of current in response to a predetermined read voltage when the respective memory cell has a threshold voltage programmed to represent a value of one; or
a negligible amount of current in response to the predetermined read voltage when the threshold voltage is programmed to represent a value of zero; and
programmable in the storage mode to have a threshold voltage positioned in one of a plurality of voltage regions, each representative of one of a plurality of predetermined values.

18. An apparatus, comprising:
an image sensing array;
a lens configured to project an image onto the image sensing array, the image having a plurality of sections;
a storage device configured to store image data representative of the image captured via the image sensing array;
a display device; and
a processor configured to:
retrieve, from the storage device in a first pass, first portions of the image data, each of the first portions configured in a separate section in the plurality of sections;
generate, based on the first portions and without at least second portions of the image data, a first preview of the image;
present, via the display device, the first preview;
retrieve, from the storage device in a second pass, the second portions of the image data, each of the second portions configured in a separate section in the plurality of sections;
generate, based on the first portions and the second portions of the image data, a second preview of the image; and
present, via the display device, the second preview.

19. The apparatus of claim 18, wherein the processor is configured to write the first portions into the storage device at first sequential addresses and write the second portions into the storage device at second sequential addresses following the first sequential addresses.

20. The apparatus of claim 19, wherein the processor is configured to present the first preview in parallel with generation of the second preview.
